(19) United States
(12) Patent Application Publication
(10) Pub. No.: US 2010/0137535 A1
(43) Pub. Date: Jun. 3, 2010

(54) POLYSTYRENE-MALEIC ANHYDRIDE/MAGNESIUM HYDROXIDE COMPOSITE PARTICLES AND METHODS FOR PREPARING THE SAME

(75) Inventors: Shiyuuichi Kimura, Susono, Shizuoka (JP); Kiyoshi Yagi, Shizuoka (JP); Makoto Egashira, Nagasaki-shi (JP)

Correspondence Address: EDWARDS ANGELL PALMER & DODGE LLP, P.O. BOX 55874, BOSTON, MA, 02205, US

(73) Assignees: Yazaki Corporation, Tokyo (JP); Nagasaki University, National University Corporation, Nagasak-shi (JP)

(21) Appl. No.: 12/312,147

(22) PCT Filed: Oct. 31, 2007
(86) PCT No.: PCT/JP2007/071597

§ 371 Date: Jan. 5, 2010

(30) Foreign Application Priority Data
Nov. 2, 2006 (JP) 2006-299239
Apr. 5, 2007 (JP) 2007-099819

(51) Int. Cl. C08F 112/08

(52) U.S. Cl. 526/194

(57) ABSTRACT

There are provided a composite particle comprising polystyrene and a filler, and having high levels of affinity between the filler and the polystyrene matrix, few or a small number of voids at the interface between the filler and the polystyrene matrix, and an excellent mechanical properties, and a method for preparing the same composite particle.

The polystyrene-maleic anhydride/magnesium hydroxide composite particle is produced by bulk polymerization of a blend of a styrene monomer, a crosslinking agent, a polymerization initiator, maleic anhydride, and magnesium hydroxide which is coated with a surface-treatment agent in advance to impart hydrophobicity thereto, and subsequently suspension polymerization of a product obtained from the bulk polymerization.

### TECHNICAL FIELD

The present invention relates to polystyrene/inorganic filler composite particle.

### BACKGROUND ART

Composite particles have been highly required for improving properties of material or developing new use or functionality in a variety of industries. Since the functionality to be required varies depending upon its portion to be used, a number of studies and researches regarding a variety of composite particles, each of which is formed of a different material or has a different shape, have been done. For example, composite particles essentially comprising polymers in which functional fillers are dispersed have been widely studied.

Meanwhile, the above mentioned composite particles essentially comprising the functional filler-dispersed polymer often lack mechanical properties.

To improve the afore-mentioned mechanical properties, polystyrene/halogen-free inorganic flame retardant composite particles have been conventionally employed as a polystyrene resin-based flame retardant. See Publication of Non-Examined Japanese Patent Application No. S61-171736. As descried previously, in a case where halogen-free inorganic flame retardant is blended with polystyrene, a large amount of magnesium hydroxide has to be added to the resulting blend to obtain high level of flame retardant ability.

However, magnesium hydroxide added in large amounts can adversely affect the mechanical properties of the final product. Accordingly, magnesium hydroxide must be used in a restricted amount, and high level of flame retardant ability therefore can hardly be achieved.

In accordance with the conventional polystyrene/halogen-free inorganic flame retardant composite particles, since polystyrene has a relatively low affinity for halogen-free inorganic flame retardant, a number of voids form at the interface therebetween. As a result, there are a number of voids inside the conventional composite particles. In other words, the composite particles that have a high true density, which means that they have few or a small number of voids therein, and also have excellent mechanical properties can hardly be achieved.

On the other hand, while a method for preparing the above mentioned composite particles comprising adding halogen-free inorganic flame retardant to styrene monomer, and polymerizing the halogen-free inorganic flame retardant with the styrene monomer to obtain a polystyrene/halogen-free inorganic flame retardant composite particles has been proposed, it was proved that most of halogen-free inorganic flame retardant is consumed during the preparation process of the polystyrene/halogen-free inorganic flame retardant composite particles. In this case, to achieve the final product containing halogen-free inorganic flame retardant in a desired amount, halogen-free inorganic flame retardant should be added in large amounts.

### DISCLOSURE OF THE INVENTION

To solve the afore-mentioned problems, there is provided a composite particle comprising polystyrene and a filler, and having high levels of affinity between the filler and the polystyrene matrix, few or a small number of voids at the interface between the filler and the polystyrene matrix, and an excellent mechanical properties. There is also provided a method for preparing the same composite particle allowing the amount of the filler consumed during the preparation process to decrease.

In accordance with an aspect of the present invention, there is provided a method for preparing a polystyrene-maleic anhydride/magnesium hydroxide composite particle, comprising (a) bulk polymerization of a blend of a styrene monomer, a crosslinking agent, a polymerization initiator, maleic anhydride, and magnesium hydroxide which is coated with a surface-treatment agent in advance to impart hydrophobicity thereto, and subsequently, (b) suspension polymerization of a product obtained from the bulk polymerization.

In the foregoing method for preparing a polystyrene-maleic anhydride/magnesium hydroxide composite particle, the surface-treatment agent is selected from the group consisting of fatty acids or esters or salts thereof, silane coupling agents, titanate-containing coupling agents, aluminum-containing coupling agents, aluminate-containing coupling agents, silicon oil, and combinations thereof.

In accordance with another aspect of the present invention, there is provided a polystyrene-maleic anhydride/magnesium hydroxide composite particle produced by a process comprising (a) bulk polymerization of a blend of a styrene monomer, a crosslinking agent, a polymerization initiator, maleic anhydride, and magnesium hydroxide which is coated with a surface-treatment agent in advance to impart hydrophobicity thereto, and subsequently, (b) suspension polymerization of the product obtained from the bulk polymerization.

### INDUSTRIAL APPLICABILITY

The foregoing method for preparing a polystyrene-maleic anhydride/magnesium hydroxide composite particle can provide several advantages. Specifically, (a) true density of the composite particle can easily be controlled, (b) the amount of halogen-free inorganic flame retardant consumed during the preparation process of the composite particle can be reduced, and (c) the composite particle having high levels of mechanical properties can be achieved.

In other words, although magnesium hydroxide is added in large amounts to obtain high levels of flame retardant ability, the rupture stress of the foregoing composite particle in accordance with the present invention will not be adversely affected. In accordance with the present invention, it is possible to prepare the composite particle having high levels of rupture stress. Also, even if magnesium hydroxide were employed in large amounts during the preparation process of the composite particle, the final product, i.e. the polystyrene-maleic anhydride/magnesium hydroxide composite particle has rupture stress comparable to that of conventional composite particle while maintaining high levels of flame retardant ability. Moreover, the composite particle having very high levels of flame retardant ability can be obtained by adding halogen-free inorganic flame retardant.

In the composite particle in accordance with the present invention, the amount of magnesium hydroxide originally added during the preparation process thereof is substantially equivalent to the content of magnesium hydroxide in the final product (i.e. the composite particle). That is to say, even if the amount of magnesium hydroxide originally added during the preparation process of the composite particle were noticeably reduced, the content of magnesium hydroxide in the final composite particle is comparable to that of conventional flame retardant composite particles. It is also interpreted that the components or ingredients of the composite particle can be well controlled in the chemical synthesis in accordance with present invention, which is comparable to a conventional physical synthesis including, for example, agitation by roller. Due to the afore-mentioned advantages, a variety of materials or products can be easily designed, and therefore a period of time needed for developing them can be largely reduced.

Further, since the polystyrene-maleic anhydride/magnesium hydroxide composite particle has few or a small number of voids at the interface between fatty acid and flame retardant, the true density of the composite particle in accordance with the present invention varies depending upon the amount of the flame retardant to be added during the preparation process of the composite particle. In other words, composite particles or shaped articles having a wide spectrum of true density can be easily designed. In the case of designing a desired material or article, pilot study itself can be reduced, and thereby a period of time needed for developing them can be largely shortened. In addition to the foregoing advantages, the composite particle in accordance with the present invention can hardly be affected by the void inside the composite particle, and thereby, flame retarding properties of magnesium hydroxide added in the preparation process can be well reflected in magnesium hydroxide-containing composite particle in accordance with the present invention.

### BEST MODE FOR CARRYING OUT THE INVENTION

To attain the foregoing objectives, the inventors tried to two approaches. One is to prepare the composite particle by carrying out bulk polymerization and subsequently suspension polymerization, and the other is to prepare the composite particle by a solvent evaporation process.

Bulk Polymerization-Suspension Polymerization Process

At first, bulk polymerization-suspension polymerization process will be herein illustrated. In accordance with a method for preparing a polystyrene-maleic anhydride/magnesium hydroxide composite particle, styrene monomer, a crosslinking agent, a polymerization initiator, maleic anhydride, and magnesium hydroxide are blended together, and the resulting blend is subjected to bulk polymerization and then suspension polymerization. Magnesium hydroxide is coated with a surface-treatment agent in advance in order to impart hydrophobicity thereto.

The crosslinking agent that is widely known to one skilled in the art can be employed in the practice of the foregoing method in accordance with the present invention. Exemplary crosslinking agent includes, but is not limited to, divinylbenzene. The crosslinking agent can be employed in an amount of 1 to 100 part(s) by weight, more specifically, 5 to 20 parts by weight based on the total of 100 parts by weight of styrene monomer.

The polymerization initiator that is widely known to one skilled in the art can be employed in the practice of the foregoing method in accordance with the present invention. Exemplary polymerization initiators includes, but is not limited to, azo compounds such as 2,2′-azobis-isobutyro-nitorile (i.e. AIBN), or peroxide compounds such as benzoyl peroxides and lauryl peroxides. The polymerization initiator can be employed in an amount of 0.1 to 5 parts by weight of the total of 100 parts by weight of styrene monomer.

In the case of adding magnesium hydroxide to the blend for preparing the composite particle in accordance with the present invention, magnesium hydroxide that is coated with surface-treatment agent in advance to impart hydrophobicity thereto can be employed.

The surface-treatment agent applied to magnesium hydroxide is adsorbed on the surface of magnesium hydroxide and thereby renders the surface of magnesium hydroxide hydrophobic. Such a surface-treatment agent includes, but is not limited to, fatty acids or esters or salts thereof, silane coupling agents, titanate-containing coupling agents, aluminum-containing coupling agents such as aluminate-containing coupling agent, silicon oil, and the combination thereof.

The foregoing silane coupling agents include, but are not limited to, vinylethoxysilane, vinyl-tris(2-methoxy)silane, gamma-methacryloxypropyltrimethoxysilane, gamma-aminopropyltrimethoxysilane, beta-(3,4-epoxycyclohexyl)ethyltrimethoxysilane, gamma-glycidoxypropyltrimethoxysilane or gamma-mercaptopropyltrimethoxysilane. Such silane coupling agents can preferably be employed in an amount of 0.1 to 5 percent by weight, more preferably, 0.3 to 1 percent by weight.

Likewise, other coupling agents such as titanate-containing coupling agents and aluminum-containing coupling agents can be employed to impart hydrophobicity to magnesium hydroxide.

Furthermore, fatty acids or salts or esters thereof include, but are not limited to, substituted or unsubstituted butyric acid, valeric acid, caproic acid, enanthic acid, caprylic acid, pelargonic acid, capric acid, lauric acid, myristic acid, pentadecylic acid, palmitic acid, heptadecanoic acid, arachidonic acid, behenic acid, lignoceric acid, crotonic acid, myristoleic acid, palmitoleic acid, trans-9-octadecenoic acid, vaccenic acid, linolic acid, linolenic acid, eleostearic acid, stearidonic acid, gadoleic acid, eicosapentaenoic acid (EPA), cis-13-docosenoic acid, clupanodonic acid, docosahexaenoic acid (DHA), or cis-15-tetracosenoic acid. Particularly, substituted or unsubstituted higher fatty acid containing 14 to 24 carbon atoms, for example, oleic acid or stearic acid will be desired. Fatty acid can preferably be employed in an amount of 0.5 to 5.0 percent by weight, more preferably, 1 to 3 percent by weight.

Illustrative silicon oil that may be useful in the practice of the invention includes methyl hydrogen polysiloxane.

The surface of magnesium hydroxide can be coated with the coupling agent via the reaction of magnesium hydroxide with the coupling agent under the condition led to coupling reaction. The surface-treatment agent other than coupling agents can also be homogeneously applied to the surface of magnesium hydroxide under the predetermined condition with respect to temperature, a period of time to be treated, or continuous agitation.

Magnesium hydroxide that may be useful in the practice of the present invention includes commercially available magnesium hydroxide that is usually intended to provide flame retarding ability. In this case, magnesium hydroxide particle can vary 0.1 to 10 μmin diameter. If the diameter of the magnesium hydroxide particle is less than 0.1 μm, the particle has a tendency to agglomerate, thereby adversely affecting the dispersibility of the magnesium hydroxide particle in styrene monomer. If the diameter of the magnesium hydroxide particle is greater than 10 μm, the resulting composite particle is likely to be formed in an irregular shape.

Magnesium hydroxide that is coated with the surface-treatment agent in advance impart hydrophobicity thereto can usually be added in an amount of up to 50 parts by weight of the total of 100 parts by weight of styrene monomer, depending upon the desired properties to be required. In accordance with the present invention, such range of amount of magnesium hydroxide will not significantly adversely affect on the rupture stress of the final product, as compared with the conventional magnesium hydroxide-containing polystyrene. The amount of magnesium hydroxide to be added in the preparation process in accordance with the present invention has to be determined in dependence with the desired rupture stress of the final product.

In addition to magnesium hydroxide component that is coated with fatty acids, maleic anhydride can be added in the preparation process for the purpose of decreasing voids that may exist at the interface between styrene resin and magnesium hydroxide. Maleic anhydride can be added in an amount of 0.5 to 10 parts by weight of the total of 100 parts by weight of styrene monomer. If maleic anhydride is added in an amount of greater than 10 parts by weight, it may adversely affect the properties of the polystyrene such as mechanical properties. If maleic anhydride is added in an amount of less than 0.5 parts by weight, the intrinsic effect as previously described can hardly be achieved.

To the blend or mixture of afore-mentioned styrene monomer, the crosslinking agent and the polymerization initiator, magnesium hydroxide that is coated with the higher fatty acid in advance and maleic anhydride are added. Magnesium hydroxide is thoroughly dispersed in the resulting blend by ultrasonic treatment, for example, for the period of 0.5 to 20 minutes. After completion of the dispersion operation, the blend is subjected to bulk polymerization.

The bulk polymerization is usually carried out at a temperature of 45˜65° C. with continuous stirring. In this case, the bulk polymerization can preferably be continued for 1 to 600 minutes insomuch as the subsequent suspension polymerization is not significantly affected by viscosity increased during the bulk polymerization. If the viscosity is noticeably increased during the bulk polymerization, subsequent suspension polymerization would not be properly carried out.

After completion of the bulk polymerization, the suspension polymerization will be carried out. Unless the subsequent suspension polymerization is performed, a composite particle in a shape of sphere can hardly be obtained. On the other hand, unless the bulk polymerization is performed prior to the suspension polymerization (i.e. in a case where only the suspension polymerization is performed), maleic anhydride can hardly be dispersed in styrene resin, and therefore magnesium hydroxide will be localized in the final composite particle. Thus, the afore-mentioned characteristic effects in accordance with the present invention can hardly be achieved.

The mixture resulting from the bulk polymerization process is added to the solution of styrene monomer and a dispersing agent such as polyvinylalcohol having polymerization degree of about 500 to 3000 and polyvinylpyrrolidone in water, and the mixture thus obtained is subjected to suspension polymerization with continuous stirring. In the preparation of the above aqueous solution, water is added in an amount of 500 parts by weight based on the total of 100 parts by weight of styrene monomer, and the dispersing agent is added in an amount of 0.5 to 3 parts by weight based on the total of 100 parts by weight of water. Stirring has to be continued at the speed enough to form a composite particle having a diameter (i.e. size) of 50 to 1000 μm until the suspension polymerization is completed. In cases where the individual suspended particles are attached to each other in the aqueous solution to form a secondary particle greater than a predetermined size, the size of the suspended particle has to be modulated. Also, it is possible to obtain suspended particles having a diameter of 1 to 50 μm by means of an emulsifying or dispersing device such as a homogenizer, a micro-channel technology and so on. The suspension polymerization may be carried out for 1 to 8 hours, with kept at a constant temperature of 65 to 80° C.

After completion of the suspension polymerization, the product thus obtained is subjected to filtration, wash with water, ethanol, or methanol, and then drying to yield polystyrene-maleic anhydride/magnesium hydroxide composite particle. After drying, if necessary, an agglomerate of the composite particles, which is also called a secondary particle and is substantially comprised of a number of original styrene-maleic anhydride/magnesium hydroxide particles (i.e. primary particles) adhered to one another, can optionally be divided into individual primary particles by means of additional treatment.

Polystyrene-maleic anhydride/magnesium hydroxide composite particle in accordance with the present invention can be suitable for use with durability-needed shaped articles such as toys, OA machinery, lighting apparatus, kitchen supplies and so on.

[Solvent Evaporation Process]

Secondly, there is herein illustrated the other approach, i.e. solvent evaporation process. In detail, the solvent evaporation process for preparing a composite particle containing polystyrene and inorganic filler includes the steps of dissolving polystyrene in suitable hydrophobic solvent such as dichloromethane, adding a functional filler such as magnesium hydroxide and calcium carbonate to the solution thus obtained to form a diffused phase, dispersing the diffused phase in PVA aqueous solution to form an emulsion, heating the resulting emulsion to remove the hydrophobic solvent, and recovering the composite particle containing polystyrene and inorganic filler.

In this solvent evaporation process, for imparting hydrophobicity to a hydrophilic material such as magnesium hydroxide and calcium carbonate, the hydrophilic material is coated with higher fatty acid such as methyl hydrogen polysiloxane (MHS), and then is subjected to heating. In this case, the use of surface-treated magnesium hydroxide is particularly advantageous to achieve a homogeneous dispersion.

### EXAMPLES

Hereinafter, a method for preparing the composite particle in accordance with the present invention will be illustrated in detail.

[One Approach: Bulk Polymerization-Suspension Polymerization Process]

Preparation of Magnesium Hydroxide Coated with Surface-Treatment Agent

1 g of Methyl hydrogen polysiloxane as surface-treatment agent, 99 g of magnesium hydroxide having a diameter of 1.2 μm as a flame retardant were placed in a cylindrical container having a diameter of 20 cm and a height of 30 cm, and equipped with a stirring bar. The mixture thus obtained were continuously stirred for 30 minutes (1600 rpm), followed by the placement of the mixture at a temperature of 150° C. for 2 hours to prepare magnesium hydroxide coated with the surface-treatment agent.

Bulk Polymerization

0.2 g of 2,2′-azobis-isobutyro-nitrile (AIBN) as a polymerization initiator and 2.0 g of divinylbenzene (DVB) as a crosslinking agent were added to 20 g of styrene monomer to obtain a mixture. 1.0 g of Maleic anhydride, and 2.0, 6.0, and 10.0 g of magnesium hydroxide that was coated with surface-treatment agent in advance to impart hydrophobicity thereto were respectively added to the above described mixture, followed by placement of the mixture in a sonic bath to prepare a dispersed phase in which magnesium hydroxide coated with the surface-treatment agent was homogeneously dispersed in styrene monomer.

The dispersed phase thus obtained was subjected to bulk polymerization for 2 hours at a temperature of 50° C. with continuous stirring (200 rpm).

Suspension Polymerization

Subsequently, 6.0 g of polyvinylalcohol (PVA) as a suspending agent was dissolved in 450 ml of ion-exchanged water. The dispersed phase obtained from the bulk polymerization was added to the resulting aqueous solution which was kept at 70° C. with continuous stirring (200 rpm). The mixture thus obtained was subsequently subjected to suspension polymerization for 4 hours.

After completion of the suspension polymerization, the product thus obtained was collected by filtration under reduced pressure, thoroughly washed with ion-exchanged water, and then dried at a temperature of 80° C. to yield three polystyrene-maleic anhydride/magnesium hydroxide composite particles in accordance with the present invention.

Result and Evaluation

Three polystyrene-maleic anhydride/magnesium hydroxide composite particles were tested and evaluated.

At first, scanning electron microscopy (SEM) and energy dispersive x-ray analysis were performed with respect to the resulting three composite particles. FIGS. 1, 3, and 5 respectively show SEM pictures of PSG-56, one of foregoing three composite particles in accordance with the present invention characterized in that magnesium hydroxide coated with surface-treatment agent was added to styrene monomer in an amount of 10 parts by weight of the total of 100 parts by weight of styrene monomer, PSG-57, another composite particle in accordance with the present invention characterized in that magnesium hydroxide coated with surface-treatment agent was added to styrene monomer in an amount of 30 parts by weight of the total of 100 parts by weight of styrene monomer, and PSG-64, the other composite particle in accordance with the present invention characterized in that magnesium hydroxide coated with surface-treatment agent was added to styrene monomer in an amount of 50 parts by weight of the total of 100 parts by weight of styrene monomer. Moreover, FIGS. 2, 4, and 6 respectively show the energy dispersive x-ray analysis on the distribution of magnesium hydroxide on the cross-section of each composite particles, i.e., PSG-56, PSG-57, and PSG-64.

Each of the foregoing polystyrene-maleic anhydride/magnesium hydroxide composite particles was granular. It was also verified that magnesium hydroxide was dispersed not only on the surface of the composite particle, but also the inside of the composite particle.

This is believed to be because viscosity resistance of magnesium hydroxide is increased in the course of bulk polymerization before suspension polymerization, and thus magnesium hydroxide is prevented from being localized in the final composite particle.

Accordingly, the shaped articles formed of the polystyrene-maleic anhydride/magnesium hydroxide composite particles in accordance with the present invention in which magnesium hydroxide is homogeneously dispersed as a flame retardant will show high levels of flame retarding properties and uniform mechanical properties.

Further, the foregoing three polystyrene-maleic anhydride/magnesium hydroxide composite particles were evaluated with respect to its strength, more particularly rupture stress.

Since there was no regulation or standard to be kept in relation to the test for measuring rupture stress of the composite particles, the original evaluation which was designed by the present inventors was employed. In detail, a microscopic compressed tester (MCT-W500) made by Simadzu Manufacturing Co., Ltd. of Japan was employed under the condition of 4500 mN of maximum testing force and 20 mN/sec of load velocity. In this test, a plane indenter has a diameter of 500 μm.

The results of the afore-mentioned test are listed in FIG. 7. The values of rupture stress calculated by the equation of Hiramatsu et al. were not remarkably lowered although the amount of magnesium hydroxide originally added in the preparation process of the composite particle was increased up to 50 parts by weight. See Yoshio Hiramatsu et al., Nippon Mining Industry Magazine, p. 1024, Vol. 81 (1965).

The present inventors suggest that this is because magnesium hydroxide which is coated with surface-treatment agent to impart hydrophobicity thereto and is contained in the composite particle in large amounts is homogeneously dispersed in the polystyrene matrix, and the resin component (i.e. polystyrene matrix) and the flame retardant component (i.e. magnesium hydroxide coated with surface-treatment agent) are coupled to each other without forming gap or clearance at the interface therebetween.

FIG. 8 shows the relationship among the measured content of magnesium hydroxide in the composite particle, the amount of magnesium hydroxide originally added in the preparation process, and apparent density.

The apparent density of the composite particles was measured by Micromeritics Gas Pycnometer Accupyc 1330 made by Simadzu Manufacturing Co., Ltd. of Japan. Specifically, the measurement was carried out by means of dry volume expansion (i.e. gas displacement).

The measurement of the magnesium hydroxide content was carried out by combusting or burning the composite particles in the air at a temperature of 1000° C., and then measuring the amount of magnesium oxide thus obtained.

FIG. 8 shows that the amount of magnesium hydroxide originally added to the blend for the preparation of the composite particle in accordance with the present invention is proportional to the measured content of magnesium hydroxide in the final product, i.e. the composite particle. Also, FIG. 8 shows that the amount of magnesium hydroxide added in the preparation process (i.e. 50 parts by weight) is substantially equivalent to the content of magnesium hydroxide in the final product (i.e. 48 parts by weight). The reasons that magnesium is efficiently taken up in the composite particle without being released from the composite particle can be found in the increased viscosity resistance, the hydrophobicity of magnesium hydroxide, and the chemical bonding of hydroxy group existing on the surface of magnesium hydroxide and styrene resin via maleic anhydride.

The chemical bonding model among the surface-treatment agent, magnesium hydroxide, maleic acid, and styrene polymer or copolymer is shown in FIG. 9.

As shown in FIG. 9, the surface-treatment agent, which is intended to impart hydrophobicity to magnesium hydroxide, for example, methyl hydrogen polysiloxane is bonded to magnesium hydroxide through dehydrogenation. On the other hand, magnesium hydroxide is bonded to styrene polymer or copolymer via maleic anhydride.

[The Other Approach: Solvent Evaporation Process]

10 Parts by weight of magnesium hydroxide obtained in the same manner as previously described was added to the solution of 100 parts by weight of commercially available polystyrene pellet in dichloromethane having boiling point of about 40° C. in order to yield a dispersion thereof. Subsequently, the dispersion was poured into the solution of polyvinylalcohol (PVA) in purified water, which was placed in a constant temperature warm bath (50° C.), with continuous stirring (300 rpm). Dichloromethane was evaporated to yield the precipitate of polystyrene.

After completion of the solvent evaporation process, the resulting product was subjected to filtration under reduced pressure, washing, and drying to collect the desired composite particles. Likewise, three composite particles in accordance with the present invention were respectively produced by adding magnesium hydroxide coated with surface-treatment agent in an amount of 30, 50, and 100 parts by weight with respect to 100 parts by weight of polystyrene.

In addition to above magnesium hydroxide component, as a filler, calcium carbonate, tetrakis-[methylene-3-(3′,5′-di-tert-butyl-4′-hydroxyphenyl)propionate]methane (antioxidant), N,N′-bis[3-(3,5-di-tert-butyl-4-hydroxyphenyl)propionyl]hydrazine (metal deactivator), magnesium 1,2-hydroxystearate (lubricant) are respectively coated with surface-treatment agent in the same manner as previously described. Each of these resulting hydrophobic fillers was respectively blended with the other component as previously described in order to prepare the composite particles in accordance with the present invention.

FIGS. 10 to 17 respectively show the characteristics of these composite particles in accordance with the present invention. FIGS. 10A to 10D are SEM (scanning electron microscope) pictures of the polystyrene composite particles prepared by the solvent evaporation process. FIGS. 10A through 10D independently show the composite particles produced by originally adding magnesium hydroxide coated with surface-treatment agent in an amount of 0, 10, 30 and 50 parts by weight based on the total of 100 parts by weight of polystyrene. Such a result also proved that the composite particle has a shape of approximate sphere, and also has a substantially smooth surface.

FIGS. 11A and 11B are SEM pictures of the composite particle in which magnesium hydroxide coated with the surface-treatment agent is originally added in an amount of 100 parts by weight based on the total of 100 parts by weight of polystyrene. FIG. 11A is an overall image of the composite particle, and FIG. 11B is an enlarged image of the surface of the composite particle depicted in FIG. 11A. By means of these pictures, it is proved that magnesium hydroxide coated with the surface-treatment agent is homogeneously dispersed in the polystyrene matrix. The foregoing composite particle has an excellent dispersibility, as compared with the composite particle produced by bulk polymerization-suspension polymerization process. Also, it is proved that the composite particle has a shape of approximate sphere, and also has a smooth surface.

FIGS. 12A and 12B are SEM pictures of the cross-section of the composite particle in which magnesium hydroxide coated with the surface-treatment agent is originally added in an amount of 100 parts by weight based on the total of 100 parts by weight of polystyrene. As shown in FIG. 12C, the energy dispersive x-ray analysis on the afore-mentioned composite particle proves that magnesium hydroxide is homogeneously dispersed in the composite particle.

FIG. 13 shows the relationship between the amount of magnesium hydroxide coated with surface-treatment agent respectively added in the bulk polymerization-suspension polymerization process and the solvent evaporation process, and the respective measured content of magnesium hydroxide content in each of the final products, i.e. the composite particles. In both cases, the amount of magnesium hydroxide originally added is proportional to the measured content of the magnesium hydroxide in the final product, and the amount of magnesium hydroxide originally added during the preparation process and the measured content of magnesium hydroxide in final product are substantially equivalent. Specially, no significant difference between the former and the latter is found in the composite particle produced by the solvent evaporation process. This result suggests that magnesium hydroxide can hardly be released from the composite particle produced by the solvent evaporation process, and therefore, the amount of magnesium hydroxide originally added is substantially the same as the content of magnesium hydroxide in the composite particle.

FIG. 14 shows the compressive strength of the composite particles which are respectively produced by the bulk polymerization-suspension polymerization process and the solvent evaporation process. In the case of the composite particle produced by the bulk polymerization-suspension polymerization process, as the amount of filler to be added originally is increased, the compressive strength of the final product, i.e. the composite particle is generally deteriorated. However, in this case, the compressive strength of the composite particle can be prevented from being remarkably deteriorated by the combination of maleic anhydride. On the other hand, the composite particle containing no magnesium hydroxide and produced by the solvent evaporation process did not appear to be deteriorated. The composite particle in which magnesium hydroxide is originally added in an amount of 100 parts by weight based on the total of 100 parts by weight of polystyrene has the compressive strength of 20 Mpa, which is not significantly different from the compressive strength (i.e. 23 Mpa) of the composite particle containing no magnesium hydroxide component. This is believed to be because a large amount of highly hydrophobic magnesium hydroxide is homogeneously dispersed in the resin matrix without forming the agglomerates of magnesium hydroxide, and also because a relatively large-sized gap, which may cause the composite particle to be ruptured, does not exist at the interface between the resin component and the flame retardant component.

FIG. 15A is SEM picture of the cross-section of the polystyrene/magnesium hydroxide composite particle produced by the bulk polymerization-suspension polymerization process, FIG. 15B is SEM picture of the cross-section of the polystyrene-maleic anhydride/magnesium hydroxide composite particle, and FIG. 15C is SEM picture of the cross-section of the polystyrene/magnesium hydroxide composite particle produced by the solvent evaporation process. In the case of the composite particle produced by the solvent evaporation process, as shown in FIG. 15C, there is no relatively large-sized gap or clearance at the interface between polystyrene resin and magnesium hydroxide, and magnesium hydroxide is homogeneously dispersed in the polystyrene matrix, which is believed to substantially supports our analysis and considerations discussed above.

### BRIEF DESCRIPTION OF THE DRAWINGS

FIG. 1 is SEM picture of the composite particle in accordance with the present invention, PSG-56.

FIG. 2 shows the energy dispersive x-ray analysis on the distribution of magnesium hydroxide on the cross-section of the composite particle in accordance with the present invention, PSG-56.

FIG. 3 is SEM picture of the composite particle in accordance with the present invention, PSG-57.

FIG. 4 shows the energy dispersive x-ray analysis on the distribution of magnesium hydroxide on the cross-section of the composite particle in accordance with the present invention, PSG-57.

FIG. 5 is SEM picture of the composite particle in accordance with the present invention, PSG-64.

FIG. 6 shows the energy dispersive x-ray analysis on the distribution of magnesium hydroxide on the cross-section of the composite particle in accordance with the present invention, PSG-64.

FIG. 7 shows the measured rupture stress values of the composite particle in accordance with the present invention.

FIG. 8 shows the relationship among the measured content of magnesium hydroxide in the composite particle, the amount of magnesium hydroxide originally added in the preparation process and apparent density.

FIG. 9 shows one illustrative example of the chemical bonding model of the composite particle in accordance with the present invention.

FIGS. 10A to 10D are SEM pictures of the polystyrene composite particles produced by the solvent evaporation process. Specifically, FIGS. 10A through 10D independently show the composite particles produced by originally adding magnesium hydroxide coated with surface-treatment agent in an amount of 0, 10, 30 and 50 parts by weight based on the total of 100 parts by weight of polystyrene.

FIGS. 11A and 11B are SEM pictures of the composite particles in which magnesium hydroxide coated with the surface-treatment agent is originally added in an amount of 100 parts by weight based on the total of 100 parts by weight of polystyrene. FIG. 11A is an overall image of the composite particle, and FIG. 11B is an enlarged image of the surface of the composite particle depicted in FIG. 11A.

FIG. 12A is SEM picture of the cross-section of composite particles in which magnesium hydroxide coated with the surface-treatment agent is originally added in an amount of 30 parts by weight based on the total of 100 parts by weight of polystyrene; FIG. 12B is an enlarged picture of FIG. 12A; and FIG. 12C is the energy dispersive x-ray analysis on the composite particle of FIG. 12A.

FIG. 13 shows the relationship between the amount of magnesium hydroxide coated with surface-treatment agent respectively added in the bulk polymerization-suspension polymerization process and the solvent evaporation process, and the respective measured content of magnesium hydroxide in each of the final products, i.e. the composite particles.

FIG. 14 shows the compressive strength of the composite particles which are respectively produced by the bulk suspension polymerization process and the solvent evaporation process.

FIG. 15A is SEM picture of the cross-section of the polystyrene/magnesium hydroxide composite particles produced by the bulk polymerization-suspension polymerization process; FIG. 15B is SEM picture of the cross-section of the polystyrene-maleic anhydride/magnesium hydroxide composite particle; and FIG. 15C is SEM picture of the cross-section of the polystyrene/magnesium hydroxide composite particle produced by the solvent evaporation process.

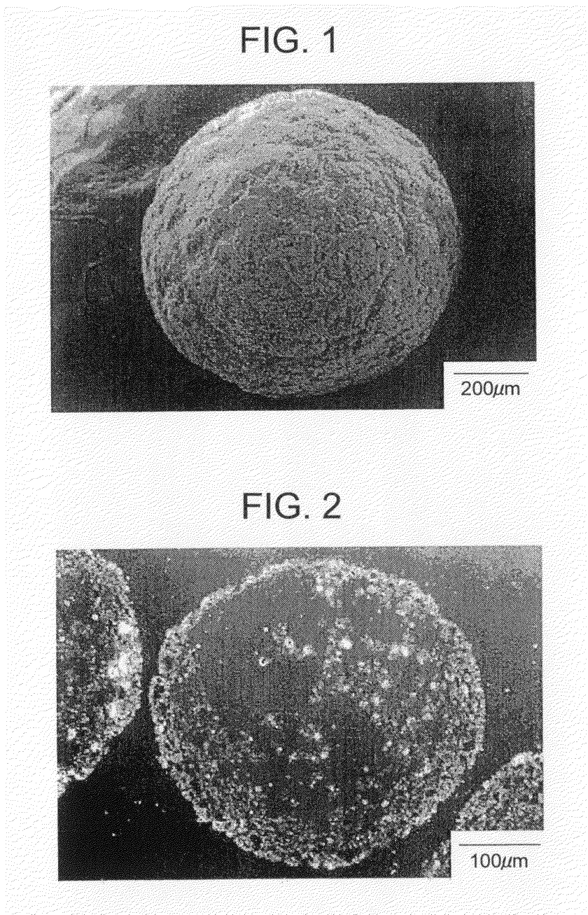

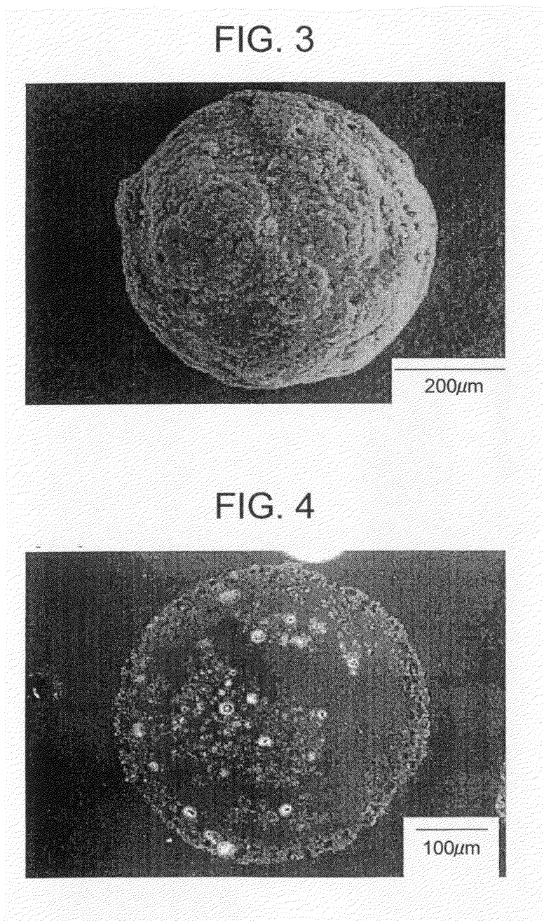

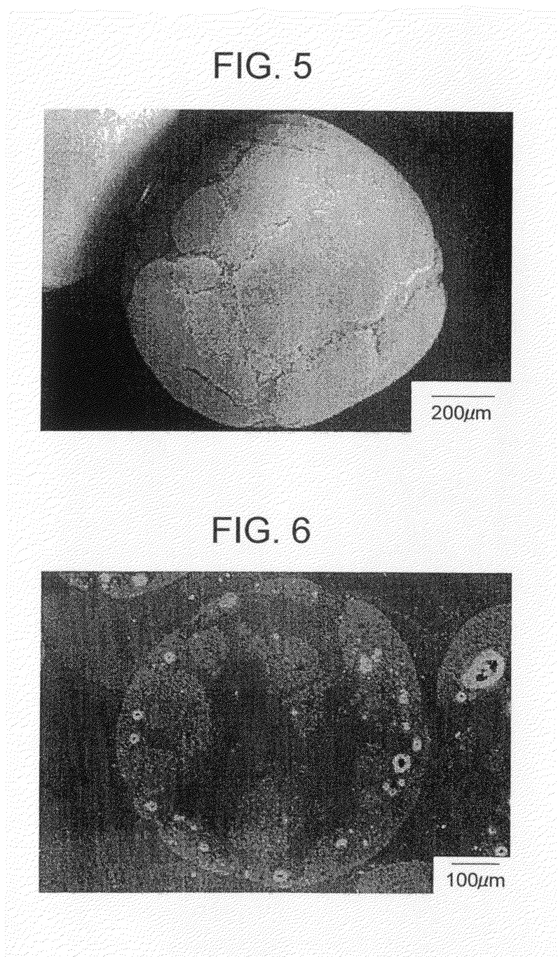

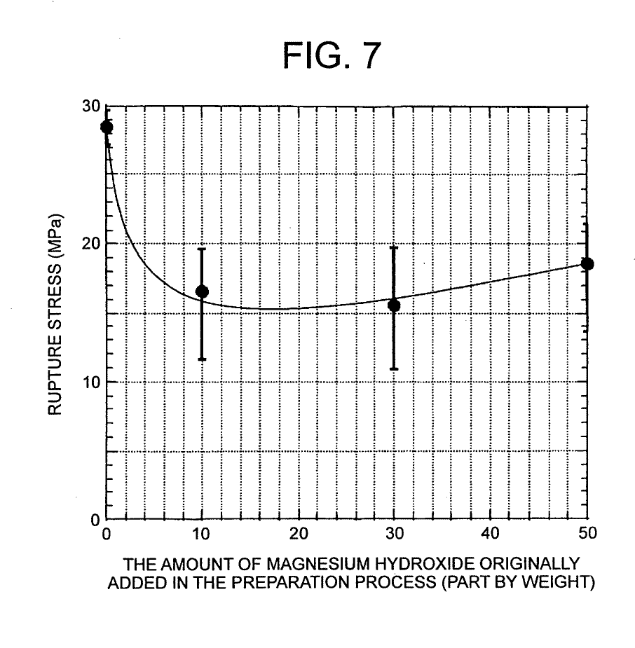

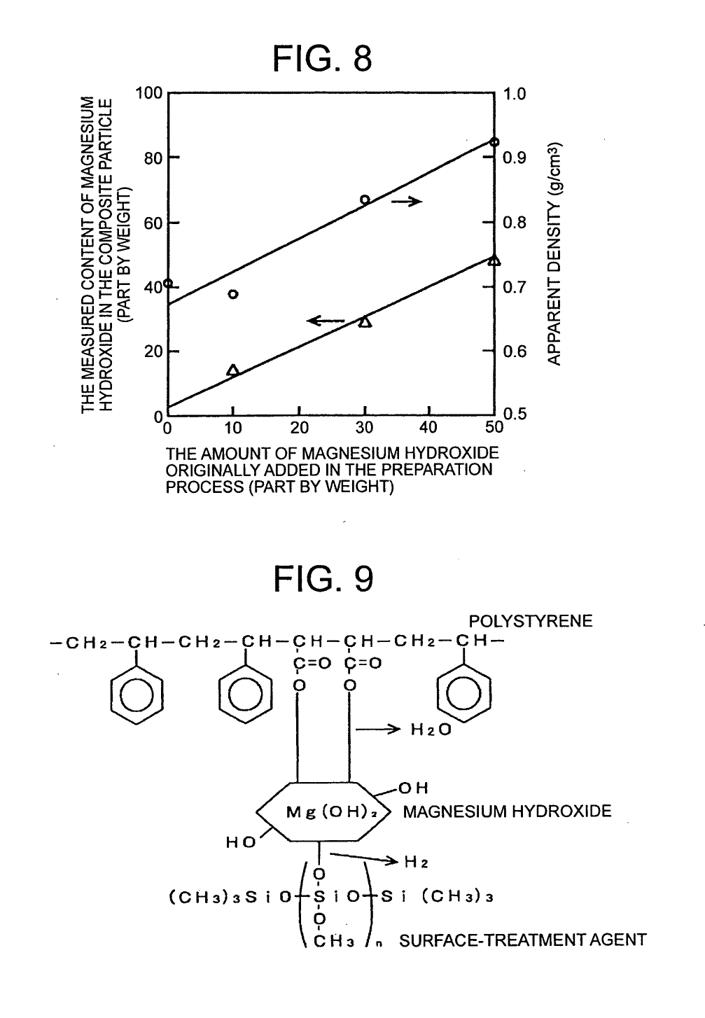

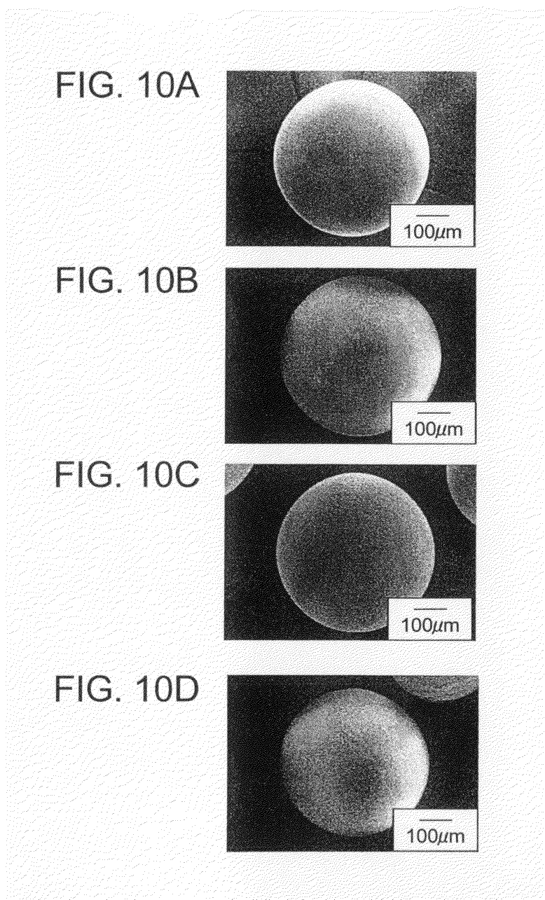

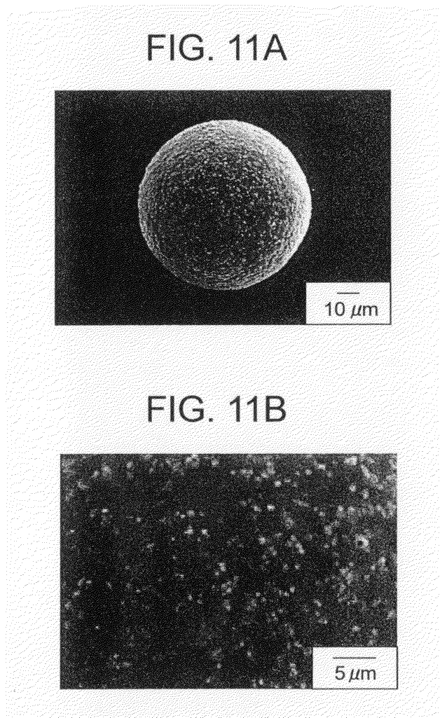

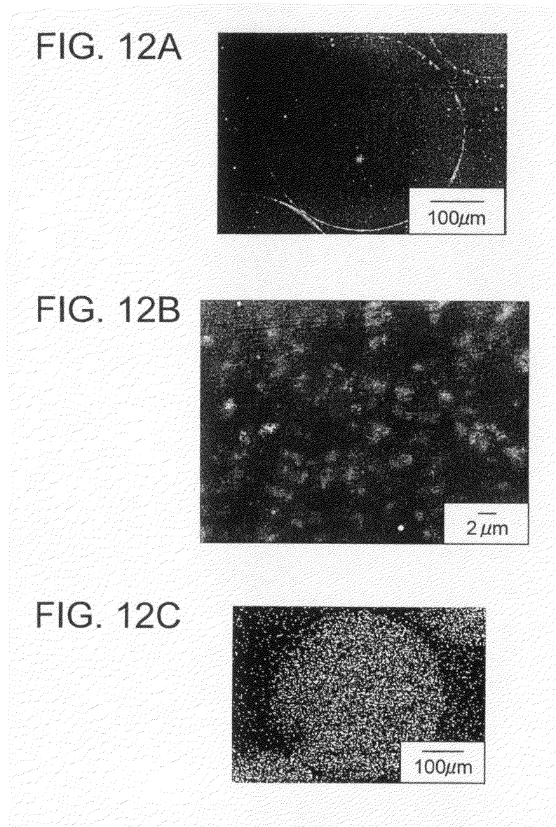

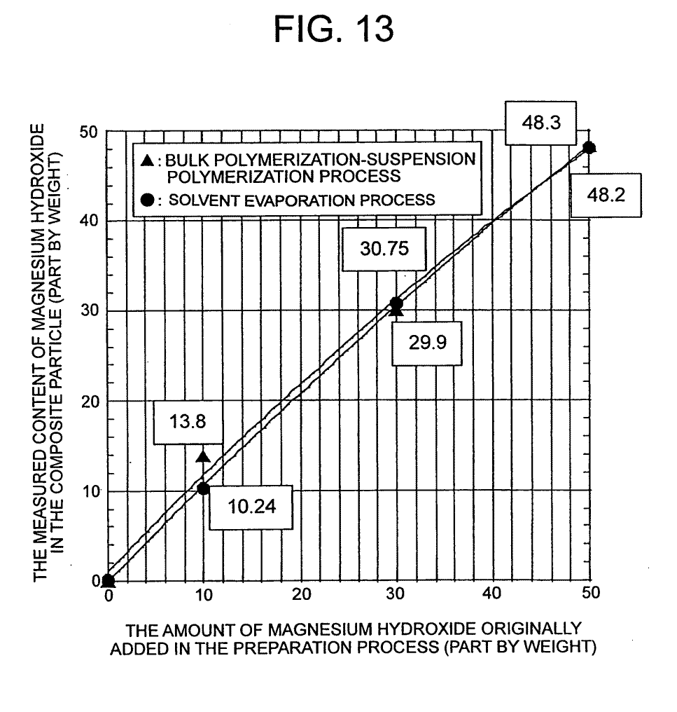

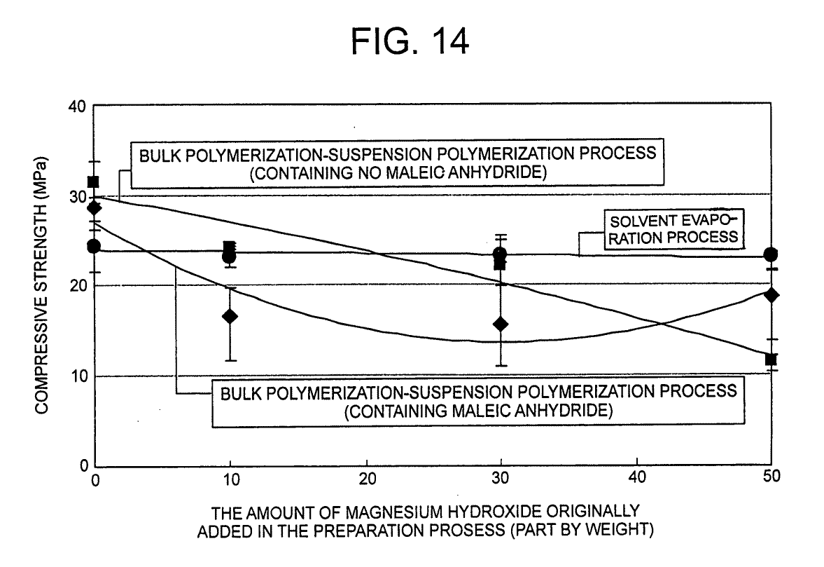

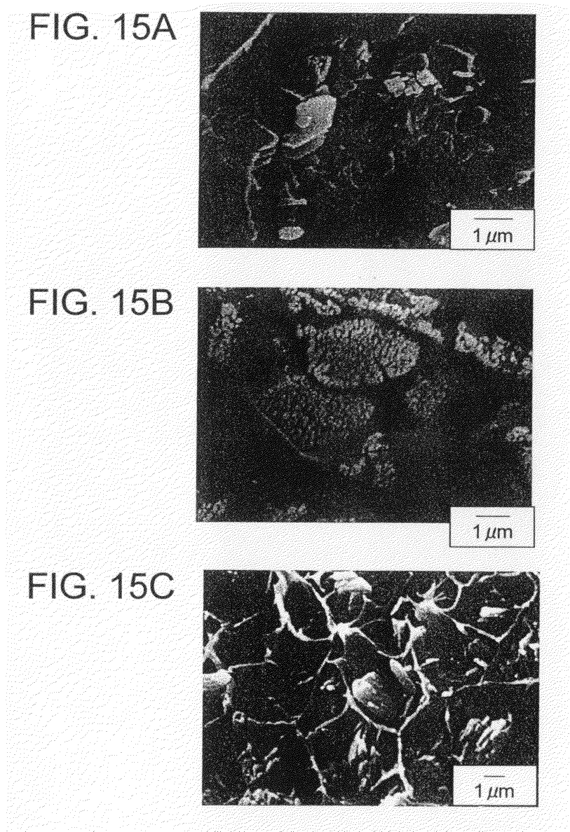

1. A method for preparing a polystyrene-maleic anhydride/magnesium hydroxide composite particle, comprising:
bulk polymerization of a blend of a styrene monomer, a crosslinking agent, a polymerization initiator, maleic anhydride, and magnesium hydroxide which is coated with a surface-treatment agent in advance to impart hydrophobicity thereto, and subsequently,
suspension polymerization of a product obtained from the bulk polymerization.

2. The method according to claim 1, wherein the surface-treatment agent is selected from the group consisting of fatty acids or esters or salts thereof, silane coupling agents, titanate-containing coupling agents, aluminum-containing coupling agents, aluminate-containing coupling agents, silicon oil, and combinations thereof.

3. A polystyrene-maleic anhydride/magnesium hydroxide composite particle produced by a process comprising:
bulk polymerization of a blend of a styrene monomer, a crosslinking agent, a polymerization initiator, maleic anhydride, and magnesium hydroxide which is coated with a surface-treatment agent in advance to impart hydrophobicity thereto, and subsequently,
suspension polymerization of a product obtained from the bulk polymerization.
